(19) United States
(12) Patent Application Publication
(10) Pub. No.: US 2019/0349748 A1
(43) Pub. Date: Nov. 14, 2019

(54) Distributed location-based system for attachment and operation of software applications on mobile devices

(71) Applicant: WATCH OUT!, INC., Del Mar, CA (US)

(72) Inventors: Michael T. Lucas, Del Mar, CA (US); Patrick Nunally, Escondido, CA (US)

(21) Appl. No.: 16/291,101

(22) Filed: Mar. 4, 2019

Related U.S. Application Data
(60) Provisional application No. 62/638,227, filed on Mar. 4, 2018.

(51) Int. Cl. H04W 8/24; H04W 4/02; H04W 4/021; G01S 19/48

(52) U.S. Cl. CPC H04W 8/24; G01S 19/48; H04W 4/021; H04W 4/025

(57) ABSTRACT

Systems and methods for obtaining electronic resources, including programming logic, on a mobile device use location data sent to a predefined network address. Location data representing the location of a mobile device is sent to a predefined network address which determines the appropriate electronic resources to return to the mobile device based upon the location data. The electronic resources themselves or references to the electronic resources are returned to the mobile device.

### CROSS REFERENCE TO RELATED APPLICATIONS

This document claims the benefit of U.S. Provisional Patent Application No. 62/638,227 filed on Mar. 4, 2018, the entirety of which is hereby incorporated by reference.

### STATEMENT REGARDING FEDERALLY SPONSORED RESEARCH OR DEVELOPMENT

This invention was not federally sponsored.

### BACKGROUND OF THE INVENTION

This invention relates to the general field of mobile electronic devices, and more specifically toward a system and method for decreasing the need for user navigation, increasing relevant application dispersal and minimizing device memory usage.

There are currently about 2.2 million software applications in each of the Apple and Google Play Applications stores. Those numbers raise the specter of the “discoverability challenge.” In other words, it is very difficult for people to find an appropriate application from amongst such a crowded index of applications. It is also important to recognize that the downloading of an application requires that it meet a threshold of need. An application that appears to have use but would be used very rarely often doesn't meet a user's threshold for downloading. An additional factor in application utilization is often referred to as “stickiness,” where rarely used applications clutter a mobile device.

Prior browsers known in the art utilize an address entered by the user, or automatically by the browser or other software application, to request data stored or produced by that address. For example, a user may enter a uniform resource locator (URL) into a browser window. This URL is parsed to determine a domain name, and a corresponding internet protocol address (IP Address) is obtained, for example, using a domain name server (DNS). The browser request is

Thus there has existed a long-felt need for a system and method for distributed electronic resources to mobile devices based on the location of the device, and without the need for the mobile device to identify what electronic resources, specifically or generally, it requires beyond identifying itself and/or its location.

### SUMMARY OF THE INVENTION

The current disclosure provides just such a solution by teaching systems and methods for obtaining electronic resources, including programming logic, on a mobile device using location data sent to a predefined network address. Location data representing the location of a mobile device is sent to a predefined network address which determines the appropriate electronic resources to return to the mobile device based upon the location data. The electronic resources themselves or references to the electronic resources are returned to the mobile device.

When a mobile device running a host application as disclosed herein crosses a physical boundary, such as the entrance to a store or service station, the previously downloaded application fetches from a server the appropriate components of a sub-application which has been previously indexed to the mobile user needs at that moment.

When a mobile device crosses into a predefined geolocation it uses the location as an address entry into a transparent browser and downloads the necessary elements needed to emulate that “location specific” application. Note that the geolocation specific applications run directly from the mobile application platform; the platform makes limited use of the mobile device's local cache and preemptively loads elements in the background based on location (that is, the software application on the mobile device loads elements into cache even when the app itself is not “open” or currently active and available for interaction by the user).

It is an object of the current disclosure to provide a system for providing location specific software applications without the need for user interaction.

It is another object of the current disclosure to provide a system for delivering location specific software application elements or resources to a mobile device.

It is a further object of this current disclosure to provide a method for distributing location specific software application resources to mobile devices to emulate installed software applications.

It is an additional object of the current disclosure to provide a system for distribution of applications which previously would have been difficult to discover.

It is another object of the current disclosure to provide a system for distribution of specific applications which previously could not have been described sufficiently to compel download.

It is a further object of the current disclosure to provide a system for distribution of applications which previously would have been rarely used and not downloaded.

It is an additional object of the current disclosure to provide a system for distribution of applications which a user of the mobile device was previously unaware of until loaded onto the mobile device.

It is another object of the current disclosure to limit the number of applications visually displayed on a mobile device to reduce home page clutter and navigation difficulty.

It is a further object of the current disclosure to enhance user accessibility of mobile applications.

It is an additional object of the current disclosure to provide a framework in which application content providers can update their applications without third party involvement, delay or terms.

It is another object of the current disclosure to provide a framework in which application content providers can provide a user experience to specific users based on their immediate needs.

It is an additional object of the current disclosure to provide a self-referencing location-based electronic content browser.

It is another object of the current disclosure to provide a locality navigated browser for mobile devices.

Embodiments of the current disclosure include a method of obtaining programming logic to be executed by one or more processors of a mobile device comprising the steps of: generating location data representing a location, transmitting the location data to a predefined network address, receiving programming logic, and executing the programming logic via the one or more processors. The method further comprising the steps of, after transmitting the location data to a predefined network address and before receiving the programming logic: receiving a uniform resource locator associated with the programming logic, and requesting the programming logic identified by the uniform resource locator. The step of generating location data representing a location comprises receiving a plurality of signals from a satellite-based radio navigation system. The location data represents geographic coordinates. Alternatively, the step of generating location data representing a location comprises receiving a land based signal that indicates the location. The location data may alternatively represents a unique identifier associated with a geo-fenced area. The network address is an internet protocol address or a uniform resource locator.

Embodiments of the current disclosure may also include a method of obtaining electronic resources on a mobile device comprising the steps of: generating location data representing a location, transmitting the location data to a predefined network address, receiving a uniform resource locator, requesting an electronic resource identified by the uniform resource locator, and receiving the electronic resource. The step of generating location data representing a location comprises receiving a plurality of signals from a satellite-based radio navigation system. The location data represents geographic coordinates. Alternatively, the step of generating location data representing a location comprises receiving a land based signal that indicates the location. The location data may also represent a unique identifier associated with a geo-fenced area. The network address may be an internet protocol address, which may be determined by using a uniform resource locator.

Further embodiments of the current disclosure may have a system comprising one or more processors executing programming logic, the programming logic configured to: generate location data representing a location of the system; transmit the location data to a predefined network address, receive an electronic resource. The network address is an internet protocol address, which may be determined by using a uniform resource locator. The electronic resource is additional programming logic. The one or more processors executing programming logic further execute the additional programming logic. The electronic resource may also or alternatively comprise a uniform resource locator for an additional electronic resource. The additional electronic resource is additional programming logic. The location data represents geographic coordinates determined by utilizing a plurality of signals from a satellite-based radio navigation system, or the location data represents a unique identifier associated with a geo-fenced area.

Additional embodiments of the current disclosure may include a method of distributing electronic resources to mobile devices comprising the steps of: receiving a request from a mobile device, where the request comprises location data indicating the location of the mobile device; determining if the location of the mobile device is within a designated zone, where the designated zone is associated with a set of electronic resources; and sending a response to the mobile device, where the responses comprises resource identifiers of the set of electronic resources. The electronic resources comprise programming logic. The resource identifiers are uniform resource locators. The electronic resources may also or alternatively comprise image data files.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future. Furthermore, the use of plurals can also refer to the singular, including without limitation when a term refers to one or more of a particular item; likewise, the use of a singular term can also include the plural, unless the context dictates otherwise.

The presence of broadening words and phrases such as “one or more,” “at least,” “but not limited to” or other like phrases in some instances shall not be read to mean that the narrower case is intended or required in instances where such broadening phrases may be absent. Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

There has thus been outlined, rather broadly, the more important features of the invention in order that the detailed description thereof may be better understood, and in order that the present contribution to the art may be better appreciated. There are additional features of the invention that will be described hereinafter and which will also form the subject matter of the claims appended hereto. The features listed herein and other features, aspects and advantages of the present invention will become better understood with reference to the following description and appended claims.

As used herein, the term location means a geographic point, area, or space; location data means data that represents a location, such as global position system (GPS) or geographic coordinates, street address, altitude, geo-fence area, or a unique identifier associated with a particular point, area, or place; network address means an identifier for a node or host on a telecommunications network, and may include an internet protocol (IP) address or media access control (MAC) address, or be determined by using a uniform resource locator (URL); predefined network address means a network address previously set or capable of being determined by a previously defined URL, and not provided or determined in real time by input from a user, and may be one of multiple predefined network addresses that are utilized by the system or method; programming logic may be represented by source code, compiled code, objects, or resources, or other electronic documents; land based signal means a signal that emanates from a terrestrial source; and a geo-fenced area is a geographic area or space identified by one or more boundaries, which may be represented in two or three dimensions.

### BRIEF DESCRIPTION OF THE FIGURES

The accompanying drawings, which are incorporated in and form a part of this specification, illustrate embodiments of the invention and together with the description, serve to explain the principles of this invention.

FIG. 1 is a diagram showing a mobile device interacting with server systems according to selected embodiments of the current disclosure.

### DETAILED DESCRIPTION OF THE INVENTION

Many aspects of the invention can be better understood with the references made to the drawings below. The components in the drawings are not necessarily drawn to scale. Instead, emphasis is placed upon clearly illustrating the components of the present invention. Moreover, like reference numerals designate corresponding parts through the several views in the drawings.

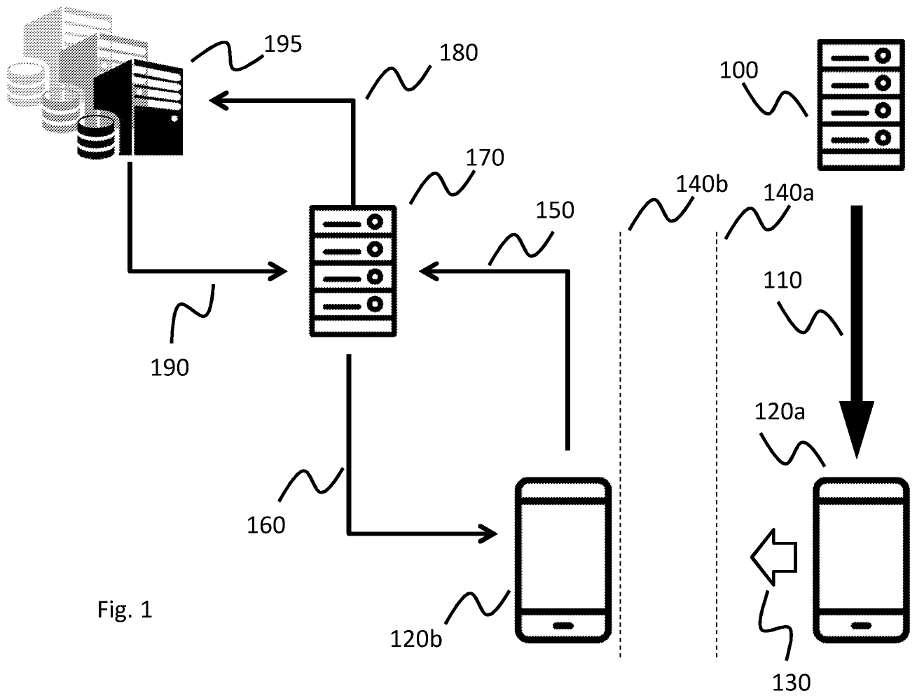

FIG. 1 is a diagram showing a mobile device interacting with server systems according to selected embodiments of the current disclosure. Server 100 stores the software application resources and makes the software application available for download by mobile devices. A mobile device 120a downloads 110 the software application. Then, the mobile device 120a moves 130 and passes a first physical boundary 140a and remains at least past or within the first physical boundary 140a for at least set period of time (that is, a first hysteresis threshold). The mobile device 120a continues past a second physical boundary 140b and remains at least past or within the second physical boundary 140b for at least a set period of time (that is, a second hysteresis threshold). Mobile device 120b represents the mobile device past both the first physical boundary 140a and second physical boundary 140b. It should be appreciated that the mobile device 120b may be within both the first physical boundary and second physical boundary at the same time.

Mobile device 120b with the software application is now in a designated zone of a sub-application. A request 150 is made to server 170 that includes data indicating a location of the mobile device 120b. The server 170 determines that the mobile device 120b is within the designated zone (that is, within the second physical boundary 140b) of a sub-application and further determines that it is appropriate for the mobile device to obtain sub-application resources. Alternatively, the mobile device 120b can determine that it is within the designated zone and at that point send a request 150 with its location to server 170; however, it is believed that this would unnecessarily consume significant resources on the mobile device. It should be appreciated that the server 170 to which request 150 is made may be the same or physical device or devices as server 100. In response to the request 150, server 170 provides a response 160 that includes the sub-application resources or references to the sub-application resources to enable the mobile device 120b to obtain it from other servers.

Server 170 may communicate with a plurality of third party servers 195. Data on sub-application usage and demographics may be sent to third party servers 195. Sub-application updates and changes 190 may be sent from third party servers 195 to server 170. Accordingly, third parties may control certain sub-applications made available to the mobile device 120a through the software application.

According to selected embodiments, when a mobile device running the software application crosses into a predefined geolocation it uses the location as an address entry into a transparent browser and downloads the necessary elements necessary to emulate that “location specific” application. Note that the geolocation specific applications may run directly from the software application platform, where the platform makes limited use of the mobile devices local cache and preemptively loads elements in the background based on location (i.e., the software application fetches elements into cache even when the software application itself isn't open).

The location of the mobile device specifies a sub-application to be presented in the mobile application.

When the user commands ‘hold” after the location based presentation of a sub application that sub application will remain presented in the application even though the location of the mobile device may change. The mobile device preloads geographic triggers in batches based on location offset and/or periodic updates of the previous device location. The mobile device will preload sub-application elements for presentation into cache upon first ingress independent of the application status.

Certain embodiments of the current disclosure are directed towards a locality navigated browser for mobile devices. Unlike prior browsers, the locality navigated browser for mobile devices as disclosed herein sends its own location to a predefined network address (or one of a plurality of predefined network addresses) to request desired resources. In addition to its own location, the browser may also send identifying data representing the individual or device when it is making its request. A system responding to such requests at the predefined network address utilizes the location data and, if provided, identifying data to determine the resources returned to the browser in response to its requests.

The locality navigated browser operates in a different fashion than those previously known. Instead of sending a request to a specific address requesting a specific resource, the locality navigated browser simply references its own location and sends the request to a predefined network address. It is the system handling the browser request that determines the appropriate resources to deliver to the browser based upon its location and, if applicable, identifying data.

The location provided by the locality navigated browser may be represented by a variety of data, including GPS coordinates, street address, altitude, geo-fence area, or other data that indicates a physical location of the browser (or user of the browser) or an area or space in which the browser (or user of the browser) is located. The self-referenced identifying data sent by the browser may be an IP Address, phone number, authentication token, or other data identifying the particular browser, mobile device, or user of the mobile device.

Embodiments of the locality navigated browser operate over standard internet protocol connections. By way of example, the browser may send a request to a server located at an IP address, and include the appropriate hyper-text transfer protocol (HTTP) headers. The body of the request will include the browser's location data and, if applicable, identifying data. However, the browser does not send any request for a specific resource or file. Rather, the server handling the request from the browser uses the location data and, if applicable, identifying data to determine the appropriate resources to formulate a response to the browser. The response body sent to the browser may include the requested resources, or alternatively, the response body may include references to the request resources, for example URLs in which instance the browser will request these resource using prior known URL requests.

The server system handling self-referencing location-based requests uses location data to determine the resources that should be returned or referenced to the browser. In some embodiments, the resources are identified as corresponding to the provided location. For example, a certain resource is associated with an area bounded by geographic coordinates. When a browser makes a request with location data indicating that the browser is within the area bounded by geographic coordinates, the server system identifies the certain resources as an appropriate response to the browser. Additionally, or in the alternative, the server system may identify a plurality of appropriate resources that are associated with one or more geographic locations at or near the location data provided by the browser. In this fashion, the browser may obtain resources applicable not only to its current position, but also applicable to positions that it may encounter in the near future. These additional resources may be cached by the local device and made immediately available to the user when the location of the mobile device indicates that such resources and then appropriate to display, activate, or otherwise make available to the user. When the resources provided by the server system based upon geographic location are no longer applicable, either as determined by the mobile device or browser, or by the server system based upon subsequent location based requests, the resources may be deleted from the mobile device.

As discussed above, the location of a mobile device may be determined by receiving a plurality of signals from a satellite-based radio navigation system, such as GPS signals, and location data indicating the location may be generated using GPS circuitry. Land based signals may also be utilized. For example, a mobile device may generate location data by utilizing near-field communication (NFC) signals and protocols, where the location data is provided via the NFC. In fact, the device that the mobile device communications via NFC may provide geographic coordinates or a unique identifier associated with the location, which is then generated (used) by the mobile device as the location data.

While possibly not preferable for certain embodiments, it is possible that the location data used by a particular system and method is not that of the mobile device requesting the electronic resources. For example, a user may select a particular location using a map service, and that location is utilized to generate the location data, which in turn is used to access the electronic resources. On the other hand, should it be preferable to only allow requests from mobile devices that are believed to be in the location they claim to be requesting electronic resources for, the server system residing at the predefined network address may verify that location of the requesting mobile device. For example, the server system may attempt to verify the location of the mobile device using a calculated round-trip-time of a request made through a switched network, which is then correlated to a distance between the server system and the mobile device. This distance may be used to validate the location indicated by the mobile device.

While various embodiments of the present invention have been described above, it should be understood that they have been presented by way of example only, and not of limitation. Likewise, the various diagrams may depict an example architectural or other configuration for the invention, which is provided to aid in understanding the features and functionality that can be included in the invention. The invention is not restricted to the illustrated example architectures or configurations, but the desired features can be implemented using a variety of alternative architectures and configurations.

Indeed, it will be apparent to one of skill in the art how alternative functional configurations can be implemented to implement the desired features of the present invention. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

That which is claimed:

1. A method of obtaining programming logic to be executed by one or more processors of a mobile device comprising the steps of:
generating location data representing a location,
transmitting the location data to a predefined network address,
receiving programming logic, and
executing the programming logic via the one or more processors.

2. The method of claim 1, further comprising the steps of:
after transmitting the location data to a predefined network address and before receiving the programming logic:
receiving a uniform resource locator associated with the programming logic, and
requesting the programming logic identified by the uniform resource locator.

3. The method of claim 1, wherein the step of generating location data representing a location comprises receiving a plurality of signals from a satellite-based radio navigation system.

4. The method of claim 1, wherein the location data represents geographic coordinates.

5. The method of claim 1, wherein the step of generating location data representing a location comprises receiving a land based signal that indicates the location.

6. The method of claim 1, where the location data represents a unique identifier associated with a geo-fenced area.

7. The method of claim 1, wherein the network address is an internet protocol address.

8. The method of claim 1, wherein the predefined network address is determined by using a uniform resource locator.

9. A method of obtaining electronic resources on a mobile device comprising the steps of:
generating location data representing a location,
transmitting the location data to a predefined network address,
receiving a uniform resource locator,
requesting an electronic resource identified by the uniform resource locator, and
receiving the electronic resource.

10. The method of claim 9, wherein the step of generating location data representing a location comprises receiving a plurality of signals from a satellite-based radio navigation system.

11. The method of claim 10, wherein the location data represents geographic coordinates.

12. The method of claim 9, wherein the step of generating location data representing a location comprises receiving a land based signal that indicates the location.

13. The method of claim 12, wherein the location data represents a unique identifier associated with a geo-fenced area.

14. The method of claim 9, wherein the network address is an internet protocol address.

15. A system comprising one or more processors executing programming logic, the programming logic configured to:
generate location data representing a location of the system;
transmit the location data to a predefined network address,
receive an electronic resource.

16. The system of claim 15, wherein the electronic resource is additional programming logic.

17. The system of claim 16, wherein the one or more processors executing programming logic further execute the additional programming logic.

18. The system of claim 15, wherein the electronic resource comprises a uniform resource locator for an additional electronic resource.

19. The system of claim 18, wherein the additional electronic resource is additional programming logic.

20. The system of claim 15, wherein the location data represents geographic coordinates determined by utilizing a plurality of signals from a satellite-based radio navigation system.
